(19) United States
(12) Patent Application Publication
(10) Pub. No.: US 2012/0145664 A1
(43) Pub. Date: Jun. 14, 2012

(54) Redundant Hoist Rope System

(75) Inventors: Myron Glickman, Arlington Heights, IL (US); Eric Brian Van Gorp, Schererville, IN (US); John J. Lanigan, JR., New Lenox, IL (US)

(73) Assignee: MI-JACK PRODUCTS, INC., Hazel Crest, IL (US)

(21) Appl. No.: 12/964,196

(22) Filed: Dec. 9, 2010

(51) Int. Cl. B66C 15/02; B66C 19/00; F16P 1/00

(52) U.S. Cl. 212/312; 212/271

(57) ABSTRACT

An apparatus capable of supporting a portion of the weight of a load being transferred by a lifting device in the event of a complete failure of one of the hoisting ropes is disclosed. The apparatus includes a support structure attached atop a beam of the lifting device, and a support bar pivotally attached to the support structure. The support structure includes a stop portion that is in contact with the beam and has an upper surface opposed to an undersurface of the support bar. A hoist system is also disclosed.

### FIELD OF THE INVENTION

This invention pertains to gantry cranes and, more particularly, to hoisting systems employed with gantry cranes.

### BACKGROUND OF THE INVENTION

Cranes and hoisting systems are used in a number of industries to lift heavy objects and reposition them someplace else. Gantry cranes, for example, are used in ship and rail yards to load and off-load containers.

A typical crane utilizes one or more wire ropes to raise and transfer a load from one place to another. In many instances, these wire ropes are used in conjunction with a stabilizing or lifting beam. While in transit, the weight of the load is distributed amongst all of the wire ropes that are used to raise and support its repositioning. Typically, more than one rope is used as the distribution of the weight amongst multiple ropes allows for greater lift capacity and also provides some measure of safety should one of the ropes fail.

While the use of multiple ropes provides a measure of safety, the potential for catastrophic failure still exists should there be a complete failure of one of the ropes. Therefore, it is desirable to have a system that would provide an added safeguard that would completely support the weight of a given load in the event of a complete failure of one of the hoisting ropes.

### BRIEF SUMMARY OF THE INVENTION

An apparatus capable of supporting a portion of the weight of a load being transferred by a lifting device in the event of a complete failure of one of the hoisting ropes is disclosed. The apparatus includes a support structure attached atop a beam of the lifting device, and a support bar pivotally attached to the support structure. The support structure includes a stop portion that is in contact with the beam and has an upper surface opposed to an undersurface of the support bar.

Also disclosed is an hoist system capable of preventing an uncontrolled dropping of a load from a lifting device. The hoist system is comprised of a beam and a stabilizing beam parallel to the beam. A hoist drum is located atop the beam and a first support bar straddles the beam and is pivotally attached to a support structure proximal to a first end of the beam. A second support bar straddles the beam and is pivotally attached to a support structure proximal to a second end of the beam. A first pair of wire ropes, each one of which is capable of supporting the entire load on one end of the stabilizing beam is wrapped around the hoist drum and has a first end attached to the hoist drum while a second end is reeved through a respective sheave, located proximal to a first end of the stabilizing beam, and is attached to the support bar. A second pair of wire ropes each one of which is capable of supporting the entire load on one end of the stabilizing beam are wrapped around the hoist drum and have a first end attached to the hoist drum and a second end reeved through a respective sheave located proximal to a second end of the stabilizing beam and attached to the second support bar.

### BRIEF DESCRIPTION OF THE DRAWINGS

FIG. 1 is a perspective of a lifting device utilizing the claimed apparatus and hoist system.

FIG. 2 is an exploded view of the claimed apparatus showing the support structure, support bar, and pivot bolt.

FIG. 3 is a perspective view showing an embodiment where the stop portion is located above the support bar.

FIG. 4 is a perspective view showing a beam and a stabilizing beam of a lifting device utilizing the claimed apparatus and hoist system.

FIG. 5 is a perspective view of the claimed apparatus proximal to the hoist drum.

FIG. 6 is a perspective view of the claimed apparatus located on the beam of a lifting device distal to the hoist drum.

FIG. 7 is a perspective view of the claimed apparatus positioned on an end of the beam of a lifting device.

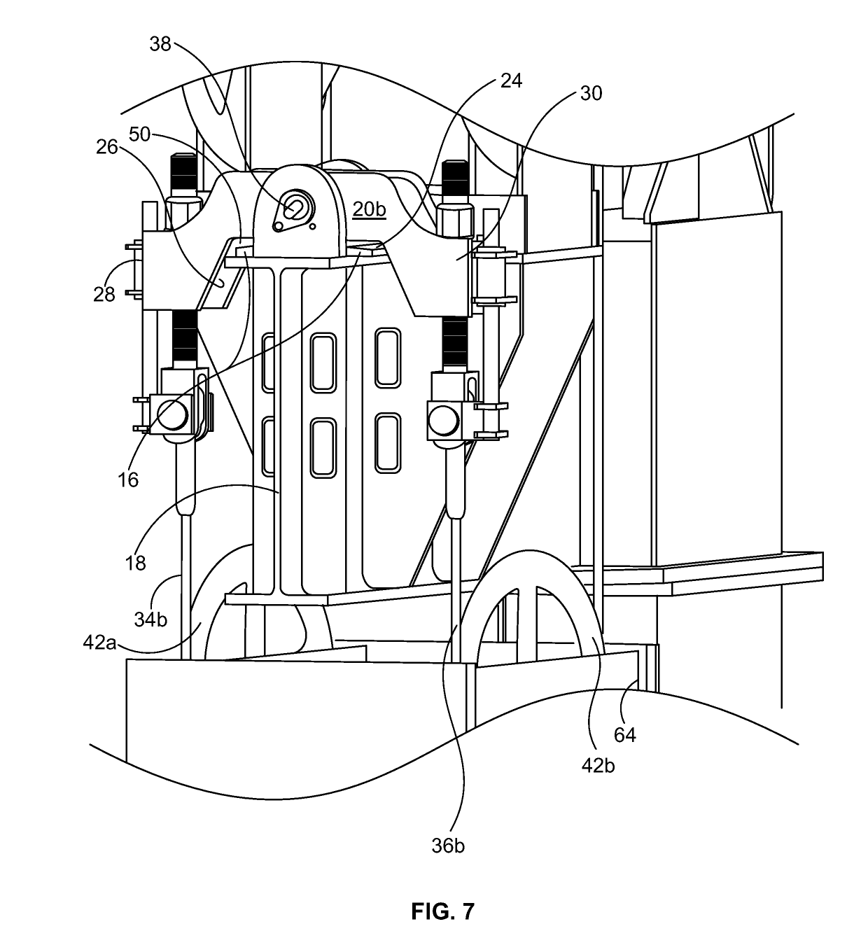

### DETAILED DESCRIPTION OF THE INVENTION

The following examples further illustrate the invention but, of course, should not be construed as in any way limiting its scope.

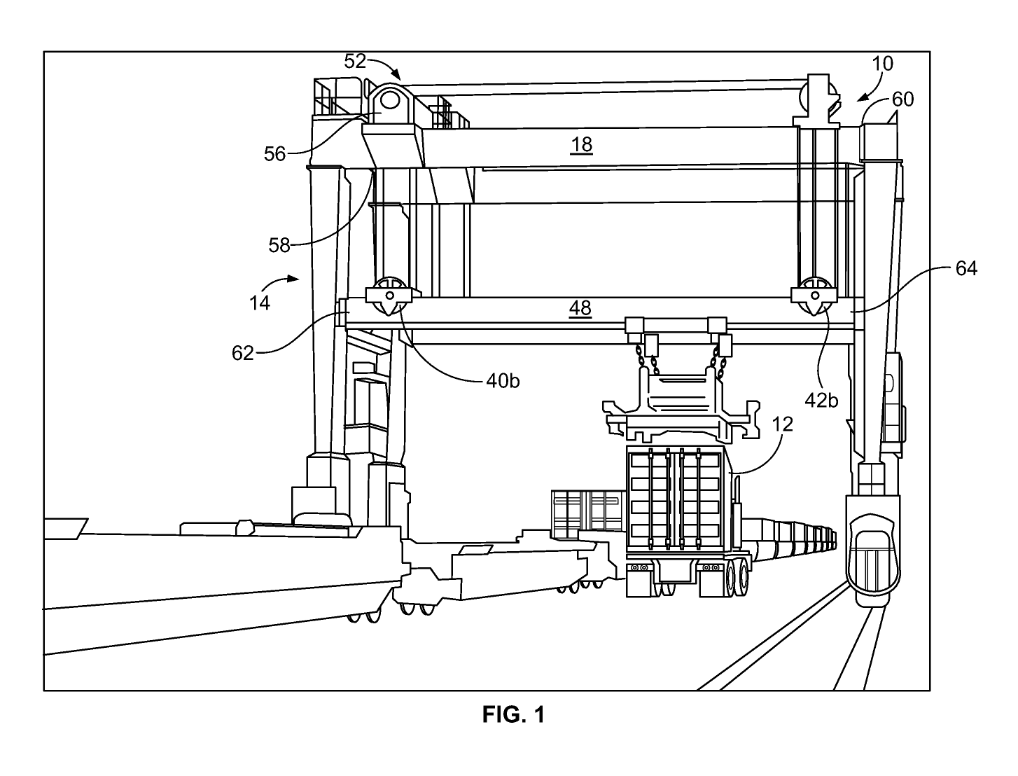

The invention involves an apparatus 10 for preventing an uncontrolled dropping of a load 12 from a lifting device 14. An embodiment related to a gantry crane is shown in FIG. 1, however, the depiction is for illustrative purposes only and does not limit the scope and usefulness of the apparatus 10 as it may be employed on any suitable lifting device.

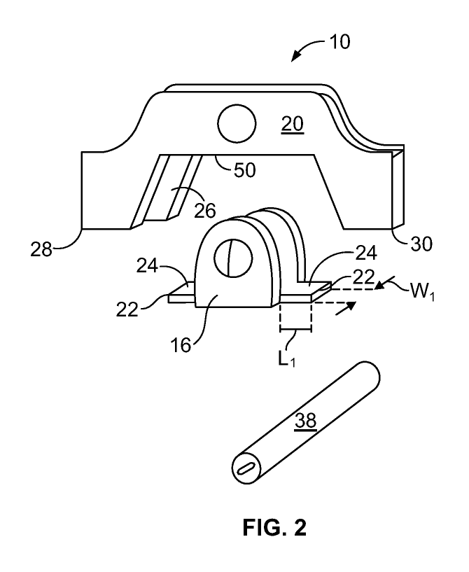

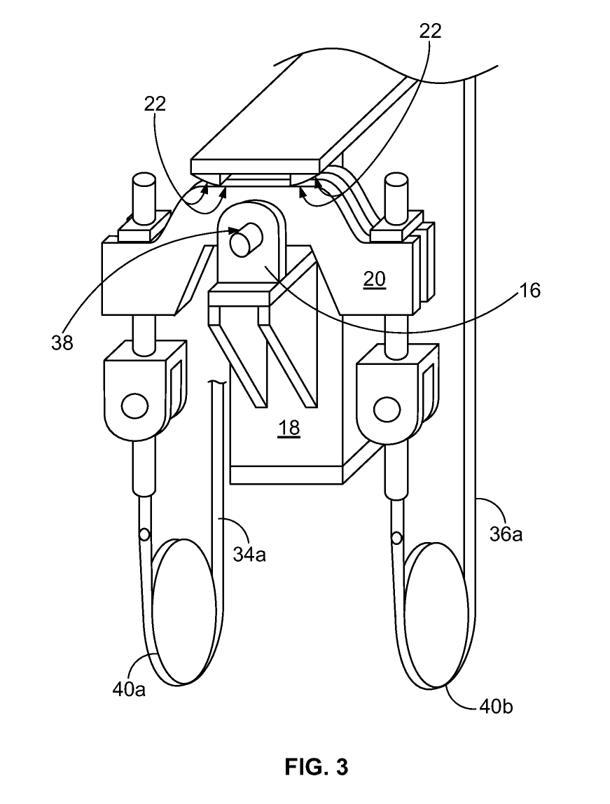

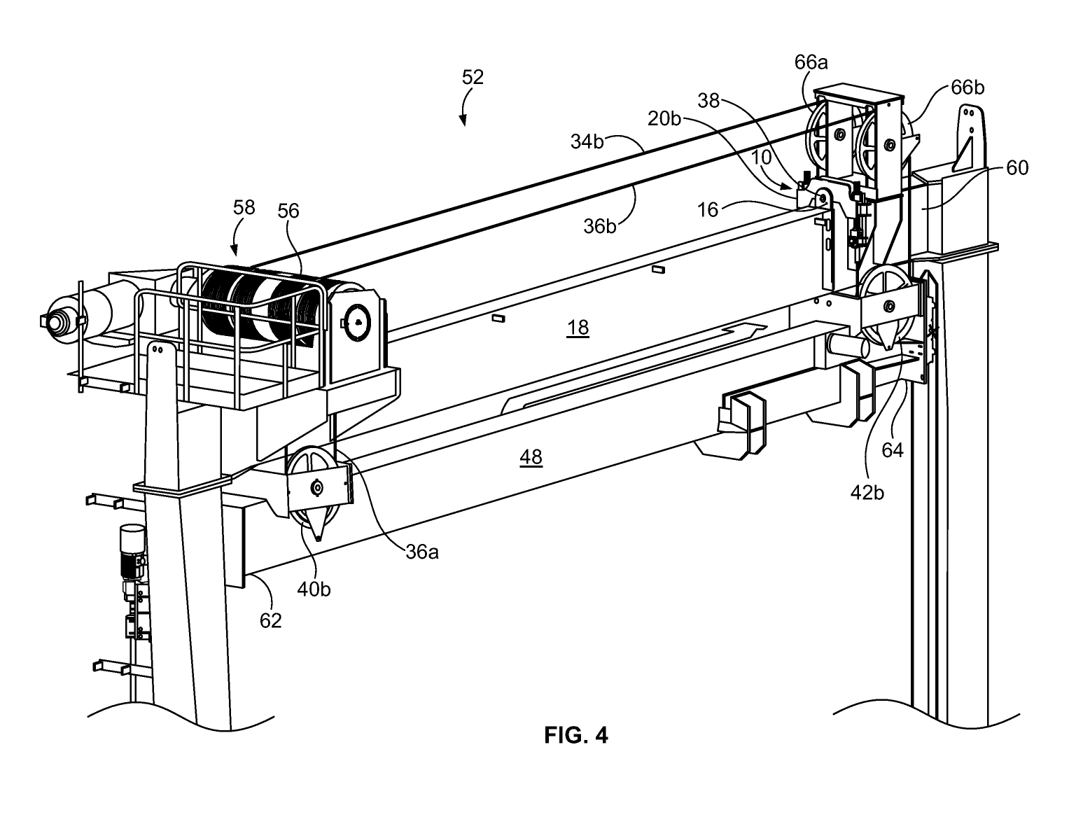

In an embodiment, the apparatus 10, as shown in FIG. 2, is comprised of a support structure 16, a support bar 20 and a pivot bolt 38. As shown in FIGS. 4-6, the support structure 16 is attached to a beam 18 of the lifting device 14. The support bar 20 is pivotally attached to the support structure 16. The support structure 16 includes a stop portion 22 that is in contact with the beam 18 and has an upper surface 24 opposed to an undersurface 26 of the support bar 20. The support bar 20 straddles the support structure 16 and the beam 18 in such a manner that the undersurface 26 of the support bar 20 is displaced from the upper surface 24 of the support structure 16. A first 28 and a second 30 end of the support bar 20, each capable of receiving an end portion of a first 34 and second 36 wire rope, respectively, extend outwardly from respective sides of the beam 18. Each of the wire ropes 34, 36 are capable of individually supporting the entire portion of the load 12 that is reflected to that side of the stabilizing beam 48. Although this disclosure illustrates the apparatus applied to one end on a stabilizing beam, the concept may be applied to other configurations that use a wire rope hoisting system including, for example, a configuration that utilizes a stop portion 22 positioned above the beam 48, as shown in FIG. 3.

In an embodiment, the support bar 20 is made of a steel, however, other suitable materials may be used without departing from the scope and spirit of the invention.

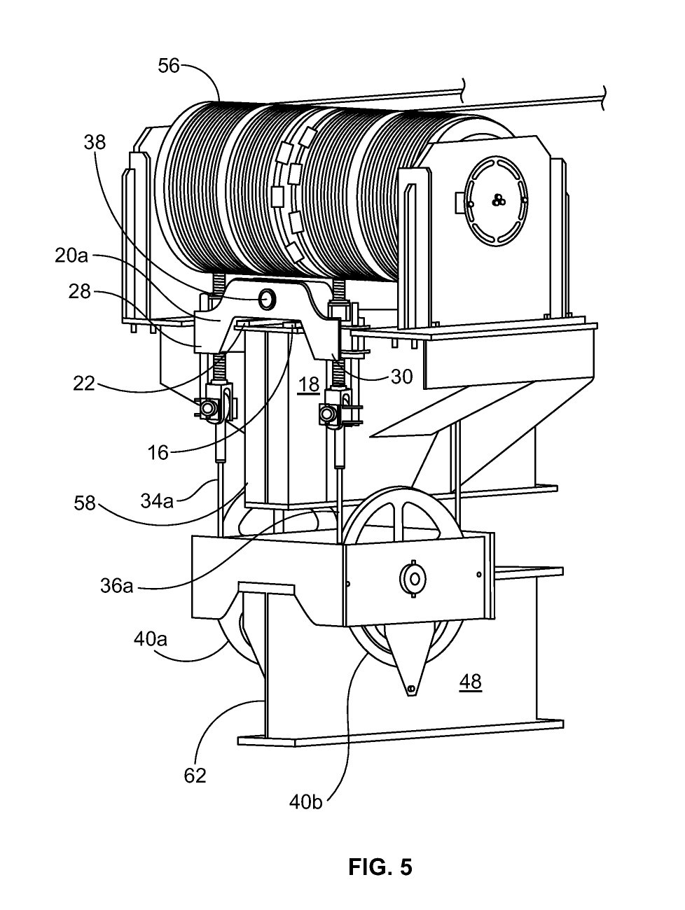

As shown in FIGS. 4-6, the pivot bolt 38 passes through the center of the support bar 20, thereby connecting the support bar 20 to the support structure 16. Each the first and second wire ropes 34a, 36a are reeved through a first and second sheave 40a, 40b, respectively, as shown in FIG. 5. Each sheave 40a, 40b is located on a respective first and second side of a stabilizing beam 48. In an embodiment, the support structure 16 has a stop portion 22 having a first width W₁ and a first length L₁ while the undersurface 26 of the support bar 20 includes a stop-portion contacting section 50 that is approximately as wide and as long as the first width W₁ and first length L₁ of the stop portion 22.

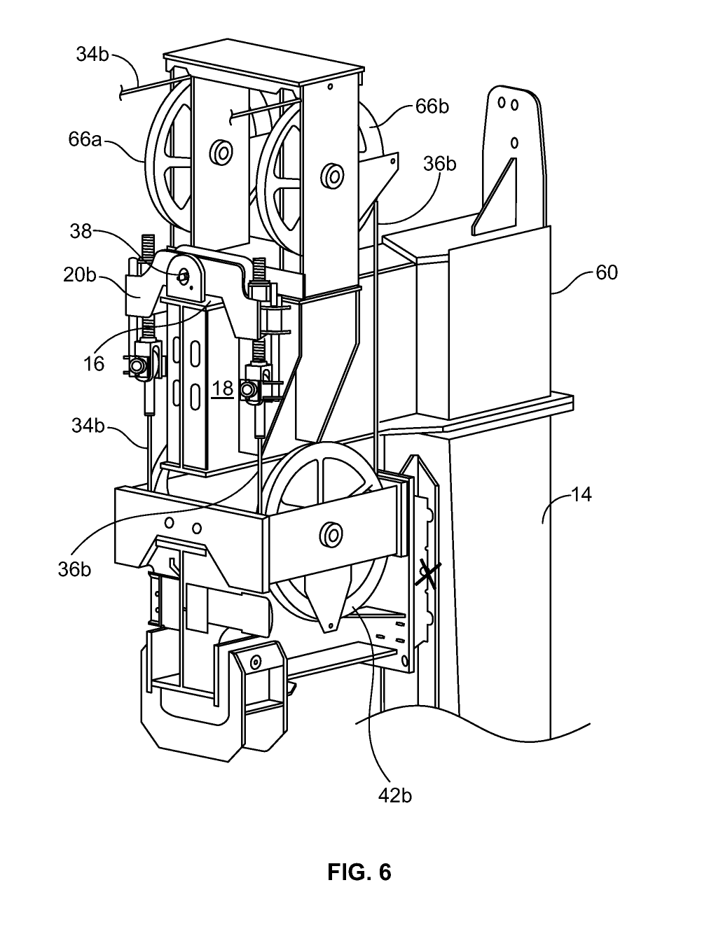

Also disclosed is a hoist system 52 capable of preventing an uncontrolled dropping of a load 12 from a lifting device 14. The hoist system 52, as shown in FIG. 4, is comprised of a beam 18 and a stabilizing beam 48 parallel to the beam 18. A hoist drum 56 is located on the beam 18 and a first support bar 20a straddles the beam 18 and is pivotally attached to a support structure 16 proximal to a first end 58 of the beam 18, as shown in FIGS. 1, 3 and 4. A second support bar 20b straddles the beam 18 and is pivotally attached to a support structure 16 proximal to a second end 60 of the beam 18. A first pair of wire ropes 34a, 36a is wrapped around the hoist drum 56 and each of the ropes in the pair of wire ropes 34a, 36a has a first end attached to the hoist drum 56 while a second end is reeved through a respective sheave 40a, 40b located proximal to a first end 62 of the stabilizing beam 48, and is attached to the support bar 20a, as shown in FIG. 5. A second pair of wire ropes 34b, 36b, is wrapped around the hoist drum 56 and each rope in the second pair of wire ropes 34b, 36b has a first end attached to the hoist drum 56 and a second end reeved through a respective sheave 42a, 42b located proximal to a second end 64 of the stabilizing beam 48, and attached to the second support bar 20b, as shown in FIG. 6.

In an embodiment shown in FIG. 4, each of the wire ropes in the first 34a, 36a and second pair 34b, 36b of wire ropes are wrapped around a single hoist drum 56. Various versions of this embodiment may be used without departing from the scope and spirit of the invention including, but not limited to, wrapping the first pair 34a, 36a of wire ropes around a first hoist drum 56 and the second pair 34b, 36b around a second hoist drum, or wrapping each wire ropes used in the hoist system around its own, respective, hoist drum.

Although the wire ropes in the hoist system are reeved through at least one sheave 42a, 42b, additional sheaves 66a, 66b may be used, such as in an embodiment as shown in FIG. 6, wherein the second end of each of the second pair of wire ropes 34b, 36b is reeved through a respective second sheave 66a, 66b attached proximal to a second end 60 of the beam 18.

In an embodiment, each of the support bars 20 includes a first end 28 and a second end 30 that extend outwardly from the respective sides of the beam 18. In a particular embodiment, the first end 28 and the second end 30 may extend outwardly and down from the respective sides of the beam 18. An underside 26 of each support bar 20 is displaced from an upper surface 24 of their respective support structures 16. In another embodiment, as shown in FIG. 2, the support structure 16 has a first width, and the undersurface 26 of the support bar 20 includes a support-structure contacting-portion 50 that is as wide as the first width of the support structure 16. In another aspect of the embodiment, the second end of a first wire rope 34a in a pair of wire ropes is attached to one of the first and second ends 28, 30 of the support bar 20 and the second end of a second wire rope 36a in a pair of wire ropes is attached to the other of the first and second ends 28, of the support bar 20. In such an embodiment, wherein one of the first and second ends 28, 30 of the support bar 20 is raised when a load 12 is removed from the rope 34a attached to the respective one of said ends 28, 30, the other of the first and second ends 28, 30 is lowered, and the underside 26 of the support bar 20 proximal to the lowered end 28, 30 contacts the upper surface 24 of the support structure 16 while the wire rope 34, 36 attached to the lowered end 26, 30 supports the entire portion of the load 12 that is reflected to that side of the stabilizing beam 48.

When in operation, a load 12 is attached to the hoist system 52 on a lifting device 14 such as the gantry crane shown in FIG. 1. The load 12 could be, for example, a container that is to be transferred from a tractor-trailer truck to a rail car or vessel, or vice versa. The hoist system 52 supports the entire load 12 once the load 12 is raised from the deck or ground, and must support the load 12 through the entire transfer in order to prevent damage to the container or its contents.

Should one of the wire ropes 34a, 34b, 36a. 36b that are included in an embodiment of the hoist system 52 fail while a lift is in operation, the claimed system provides an apparatus 10 that allows the lifting device 14 to retain control of the load 12, thereby preventing catastrophic damage to the load 12 or personnel in the area of the lifting device 14. This results from the fact that once one of the wire ropes 34a, for example, as shown in FIG. 5, fails, the load 12 associated with that rope 34a is removed from the respective one end 28 of the support bar 20. This causes the support bar 20 to pivot as the load 12 on a second wire rope 36a attached to the opposite end 30 of the support bar 20 pulls the opposite end 30 downward until the underside 26 of the support bar 20 proximal to the opposite end 30 contacts the support surface 24 of the support structure 16. Once the underside 26 of the support bar 20 contacts the support surface 24, a portion of the load 12 is transferred from the opposite end of the support bar 20 to the support surface 24, thereby reducing tension on the second wire rope 36a and preventing catastrophic failure of the hoist system 52.

In another embodiment, as shown in FIG. 3, a stop contacting portion 22 having a first width and a first length is located above the support bar 20. In this particular embodiment, the upper surface of the support bar 20 includes a stop-portion contacting section that is approximately as wide and as long as the first width and first length of the stop portion 22. As in other embodiments, one of the first and second ends 28, 30 of the support bar 20 is raised when a load is removed from the rope attached to the respective one of said ends. This results in the other of the first and second ends 28, 30 being lowered. As the one end is raised, the upper surface of the support bar 20 proximal to said raised end contacts the stop contacting portion 22 located above the support bar 20, thereby reducing tension on the wire rope attached to the lowered end and preventing a catastrophic failure.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the claimed apparatus, device, system or method (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the claimed apparatus, device, system or method and does not pose a limitation on the scope of the claimed apparatus, device, system or method unless otherwise claimed. No language in the specification should be construed as indicating any non-claimed element as essential to the practice of the claimed apparatus, device, system or method.

Preferred embodiments of the claimed apparatus, device, system or method are described herein, including the best mode known to the inventors for carrying out the claimed apparatus, device, system or method. It should be understood that the illustrated embodiments are exemplary only, and should not be taken as limiting the scope of the claimed apparatus, device, system or method.

What is claimed is:

1. A safety apparatus for preventing an uncontrolled dropping of a load from a lifting device, the safety device comprised of:
a support structure attached to a beam of the lifting device; and
a support bar pivotally attached to the support structure, said support bar straddling the beam and having an undersurface displaced from an upper surface of the support structure;
a first and a second end of the support bar extending outwardly from respective sides of the beam,
wherein each of the first and second ends of the support bar are capable of receiving an end portion of a first and second wire rope, respectively.

2. The safety apparatus of claim 1, wherein:
the support structure includes a stop portion having a first width and a first length; and
the undersurface of the support bar includes a stop-portion contacting section that is approximately as wide and as long as the first width and first length of the stop portion.

3. The safety apparatus of claim 1, wherein
a stop contacting portion having a first width and a first length is located above the support bar; and
the upper surface of the support bar includes a stop-portion contacting section that is approximately as wide and as long as the first width and first length of the stop portion.

4. The safety apparatus of claim 1, wherein a pivot bolt passing through the center of the support bar connects the support bar to the support structure.

5. The safety apparatus of claim 1, wherein:
the support structure is attached atop a beam of the lifting device
each of the first and second wire ropes are reeved through a first and second sheave, respectively; and
each sheave is located on a respective first and second end of a stabilizing beam.

6. The safety apparatus of claim 1, wherein:
a first and second threaded connector attaches the respective end portion of each of the first and second wire ropes to the respective first and second ends of the support bar.

7. The safety apparatus of claim 1, wherein the first and the second end of the support bar extending outwardly and down from respective sides of the beam,

8. A hoist system capable of preventing an uncontrolled dropping of a load from a lifting device, the hoisting system comprised of:
a beam and a stabilizing beam parallel to the beam;
a hoist drum located on the beam;
a first support bar straddling the beam and pivotally attached to a support structure proximal to a first end of the beam;
a second support bar straddling the beam and pivotally attached to a support structure proximal to a second end of the beam;
a first pair of wire ropes wrapped around the hoist drum, each rope in the pair of wire ropes having a first end attached to the hoist drum, a second end reeved through a respective sheave located proximal to a first end of the stabilizing beam and attached to the first support bar; and
a second pair of wire ropes, each rope in the second pair of wire ropes being wrapped around the hoist drum and having a first end attached to the hoist drum, a second end reeved through a respective sheave located proximal to a second end of the stabilizing beam, and attached to the second support bar.

9. The hoist system of claim 8, wherein the second end of each rope of the second pair of wire ropes is reeved through a sheave attached to a second end of the beam.

10. The hoist system of claim 8, wherein:
each of the dead end support bars includes a first end and a second end that extend outwardly from the respective sides of the beam, and an underside that is displaced from an upper surface of their respective support structures.

11. The hoist system of claim 10, wherein:
the support structure has a first width; and
the undersurface of the support bar includes a support structure contacting portion that is as wide as the first width of the support structure.

12. The hoist system of claim 10, wherein the second end of a first wire rope in a pair of wire ropes is attached to one of the first and second ends of the support bar and the second end of a second wire rope in a pair of wire ropes is attached to the other of the first and second ends of the support bar.

13. The hoist system of claim 12, wherein:
one of the first and second ends of the support bar is raised when a load is removed from the rope attached to the respective one of said ends, the other of the first and second ends is lowered;
the underside of the support bar proximal to the other of the first and second end contacts the upper surface of the support structure; and
the wire rope attached to the lowered end of the support bar is capable of individually supporting the entire portion of the load that is reflected to the lowered end of the support bar.

14. The hoist system of claim 12, wherein
a stop contacting portion having a first width and a first length is located above the support bar;
the upper surface of the support bar includes a stop-portion contacting section that is approximately as wide and as long as the first width and first length of the stop portion.
one of the first and second ends of the support bar is raised when a load is removed from the rope attached to the respective one of said ends, the other of the first and second ends is lowered;
the upper surface of the support bar proximal to said raised end contacts the stop contacting portion located above the support bar; and
the wire rope attached to the lowered end of the support bar is capable of individually supporting the entire portion of the load that is reflected to the lowered end of the support bar.

15. The hoist system of claim 8, wherein:
the first pair of wire ropes are wrapped around a first hoist drum; and
the second pair of wire ropes are wrapped around a second hoist drum.

16. The hoist system of claim 8, wherein each of the wire ropes in the first and second pair of wire ropes is wrapped around its own respective hoist drum.
